(19) United States
(12) Patent Application Publication
(10) Pub. No.: US 2007/0114852 A1
(43) Pub. Date: May 24, 2007

(54) Parallel uninterruptible power supply system

(75) Inventors: Hung-Chieh Lin, Taoyuan (TW); Jen-Chuan Liao, Taoyuan (TW); Kuo-Chiang Lung, Taoyuan (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/328,333

(22) Filed: Jan. 9, 2006

(30) Foreign Application Priority Data
Nov. 18, 2005 (TW) 094140673

(51) Int. Cl. H02J 9/00

(52) U.S. Cl. 307/66

(57) ABSTRACT

Provided is a parallel uninterruptible power supply system including a first uninterruptible power supply and a second uninterruptible power supply connected in parallel with each other, and a connector interconnecting a first signal transmission line of the first uninterruptible power supply and a second signal transmission line of the second uninterruptible power supply. A first control module of the first uninterruptible power supply can directly receive data signal outputted from a second power supply module and a second battery module of the second uninterruptible power supply, and a second control module of the second uninterruptible power supply can directly receive data signal outputted from a first power supply module and a first battery module of first uninterruptible power supply, so that the first uninterruptible power supply and the second uninterruptible power supply can communicate directly with each other.

### FIELD OF THE INVENTION

The present invention is related to an uninterruptible power supply system, and more particularly to a parallel uninterruptible power supply system.

### BACKGROUND OF THE INVENTION

Uninterruptible power supply (UPS) is an emergent power supply device connected between a power source and a load, in which the power source can be a commercial AC power supply or any other AC power source. The uninterruptible power supply is configured to supply the power required for powering a load in an emergent condition so as to ensure the normal operation for the load when the power source becomes abnormal.

In order to protect important electronic equipment with more efficiency and safety, UPS has been extensively employed to ensure the normal operation for various electronic devices. More particularly, a parallel UPS system has been testified to be the best choice for providing high quality, high continuity electric power to electronic devices that are vulnerable to the problem of power outage.

FIG. 1 shows a circuit block diagram of a parallel UPS system according to the prior art. As shown in FIG. 1, a parallel UPS system 10 is connected between a power source 11 and a load 16 for continuously and stably supplying the electric power required for powering the load 16. The parallel UPS system 10 is made up of a first uninterruptible power supply (first UPS) 12, a second uninterruptible power supply (second UPS) 13, a connector 14, and a distribution box 15. The first UPS 12 and the second UPS 13 receive AC power from the power source 11 and perform rectification, filtration and conversion to the received AC power, and output electric power respectively. The distribution box 15 is configured to receive the power outputted from the first UPS 12 and the second UPS 13, and supply an operative power for the load 16 in accordance with the requirements of the load 16. Besides, each of the first UPS 12 and the second UPS 13 include an external communication port 126, 136 for transmitting the system status information and associated data signal to the other uninterruptible power supply, so that the first UPS 12 and the second UPS 13 can communicate with each other to equally share the operative power for the load 16. If one of the uninterruptible power supplies is malfunctioned, the other uninterruptible power supply can adjust its share of the operative power by means of the signal transmission between the communication ports 126, 136. The connector 14 is configured as a signal transmission medium for the external transmission ports 126, 136.

FIG. 2 shows a circuit block diagram detailing the internal circuitry of the parallel UPS system of FIG. 1, in which the circuit architecture of the first UPS 12 and the circuit architecture of the second UPS 13 are alike. As shown in FIG. 2, the first UPS 12 is made up of a switch device 121, a power supply module 122, a microprocessor 123, a battery module 124, a control module 125, an external communication port 126, and a display 127, in which the external communication port 126 includes an internal communication chip 1261. Likewise, the second UPS 13 is made up of a switch device 131, a power supply module 132, a microprocessor 133, a battery module 134, a control module 135, an external communication port 136, and a display 137, in which the external communication port 136 includes an internal communication chip 1361.

In the circuit block diagram of FIG. 2, the solid arrowheaded lines represent power transmission lines and the dashed arrowheaded lines represent signal transmission lines. As shown in FIG. 2, the power source 11 supplies the electric power required for powering the switch devices 121, 131, the power supply modules 122, 132, and control modules 125, 135 of the first uninterruptible power supply 12 and the second uninterruptible power supply 13. The control modules 125, 135 are configured to perform signal transmission by means of the switch devices 121,131, the microprocessors 122, 132 of the power modules 122, 132, battery modules 124, 134, and voltage output terminals (not shown).

The power supply modules 122, 132 of the first UPS 12 and the second UPS 13 are configured to process the AC power received from the power source 11 and output the processed electric power to the distribution box 15 through the switch devices 121, 131, respectively. Also, the power supply modules 122, 132 are configured to convert the AC power into DC power and store the DC power in the battery modules 124, 134, respectively. The microprocessors 123,133 are configured to transmit the status information of the power supply modules 122, 132 to the control modules 125, 135. Also, the battery modules 124,134 can transmit their status information to the control modules 125, 135.

The switch devices 121, 132 are under the control of the control modules 125, 135, respectively. When the control modules 125, 135 detect that the output voltages S1, S2 of the power supply modules 122, 132 are abnormal, i.e. the power supply modules 122, 132 are malfunctioned or the AC power derived by converting the DC power supplied from the battery modules 124, 134 can not meet the requirements of the load 16, a control signal is issued to the switch devices 121, 131 to allow the power source 11 to provide the output voltages S1, S2. The displays 127, 137 are configured to display the system status information of the first UPS 12 and the second UPS 13.

Because the first uninterruptible power supply 12 and the second uninterruptible power supply 13 are necessary to communicate with each other, the control module 125 and the control module 135 13 are configured to conduct signal transmission through respective external communication ports 126, 136. That is, the signals outputted from the microprocessors 123, 133 and the signals outputted from the battery modules 124, 134 are first transmitted to the control modules 125, 135 and then respectively transmitted to the external transmission port of the other uninterruptible power supply. This ensures that the uninterruptible power supplies 12 and 13 share the system status information with each another. The uninterruptible power supplies can communicate with each other by means of the signal transmission and can further equally share the operative power for the load 16.

As stated above, the signals outputted from the microprocessors 123, 133 and the battery modules 124, 134 are first transmitted to the control modules 125, 135 and then respectively transmitted to the other uninterruptible power supply through the external communication ports 126, 136. Such communication mode would result in a long communication path and cause the slowness of the signal transmission, which would in turn prolong the response time of the entire uninterruptible power supply system 10. More disadvantageously, both of the external communication ports 126, 136 have complicated circuit architecture and require an internal communication chip 1261, 1361 to conduct signal transmission, which would increase the manufacturing cost and deteriorate the product competitiveness.

There is a need to develop a parallel uninterruptible power supply system in which the internal uninterruptible power supplies can communicate with each other without the need of an external communication port.

### SUMMARY OF THE INVENTION

An object of the present invention is to provide a parallel uninterruptible power supply system that can conduct signal transmission between the internal uninterruptible power supplies without the need of a communication port. Therefore, the inventive parallel uninterruptible power supply system can provide a faster signal transmission rate and a shorter response time, and can further reduce the manufacturing cost by eliminating the internal communication chip located within of the communication port.

Another object of the present invention is to provide a parallel uninterruptible power supply system that can conduct signal transmission between the internal uninterruptible power supplies by means of signal transmission lines, so that each internal uninterruptible power supply can receive the data signal outputted from the power supply module of the other uninterruptible power supply to achieve multilateral communication between the internal uninterruptible power supplies.

To this end, a broader aspect of the present invention provides a parallel uninterruptible power supply system, which at least includes a first uninterruptible power supply, a second uninterruptible power supply, and a connector. The first uninterruptible power supply includes a first control module, a first power supply module, a first battery module, and a first signal transmission line connected to the first control module, the first power supply module, and the first battery module for transmitting data signal outputted from the first power supply module and the first battery module. In addition, a second uninterruptible power supply is connected in parallel with the first uninterruptible power supply and includes a second control module, a second power supply module, a second battery module, and a second signal transmission line connected to the second control module, the second power supply module, and the second battery module for transmitting data signal outputted from the second power supply module and the second battery module. The connector is connected with the first signal transmission line and the second signal transmission line for allowing the first control module to receive data signal directly from the second power supply module and the second battery module and allowing the second control module to receive data signal directly from the first power supply module and the first battery module, so that the first uninterruptible power supply and the second uninterruptible power supply can communicate directly with each other.

Now the foregoing and other features and advantages of the present invention will be best understood through the following descriptions with reference to the accompanying drawings, wherein:

### BRIEF DESCRIPTION OF THE DRAWINGS

FIG. 1 is a circuit block diagram of a parallel UPS system according to the prior art;

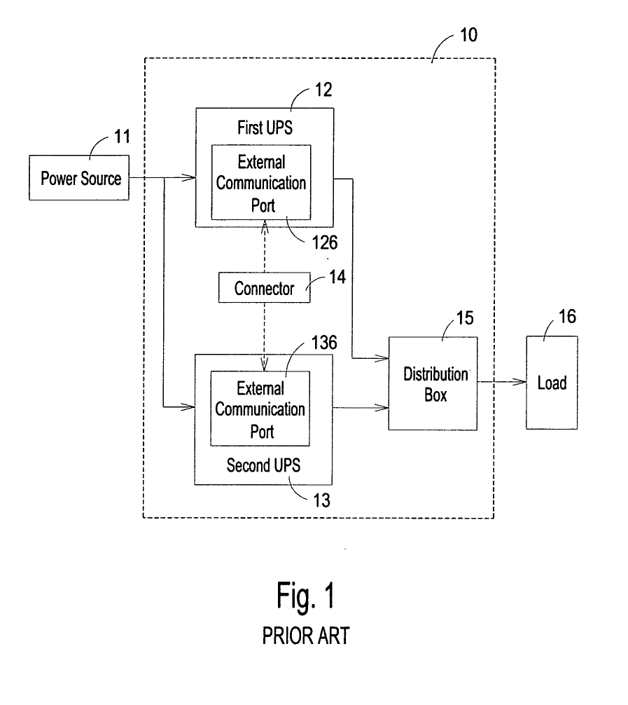

FIG. 2 is a circuit block diagram detailing the parallel UPS system of FIG. 1;

FIG. 3 is a circuit block diagram of a parallel UPS system according to a first preferred embodiment of the present invention;

FIG. 4 is a circuit block diagram of a parallel UPS system according to a second preferred embodiment of the present invention;

FIG. 5 is a circuit block diagram detailing the internal circuitry of the parallel UPS system of FIG. 4; and

FIG. 6 is an elevation view of a parallel UPS system according to a preferred embodiment of the present invention.

### DETAILED DESCRIPTION OF THE PREFERRED EMBODIMENT

Several preferred embodiments embodying the features and advantages of the present invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

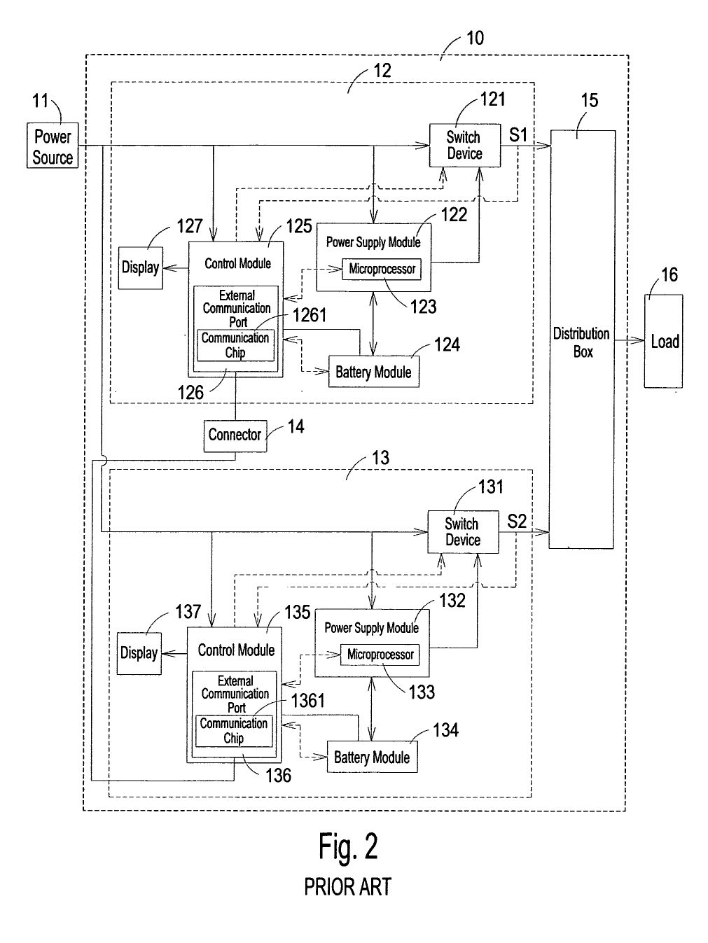

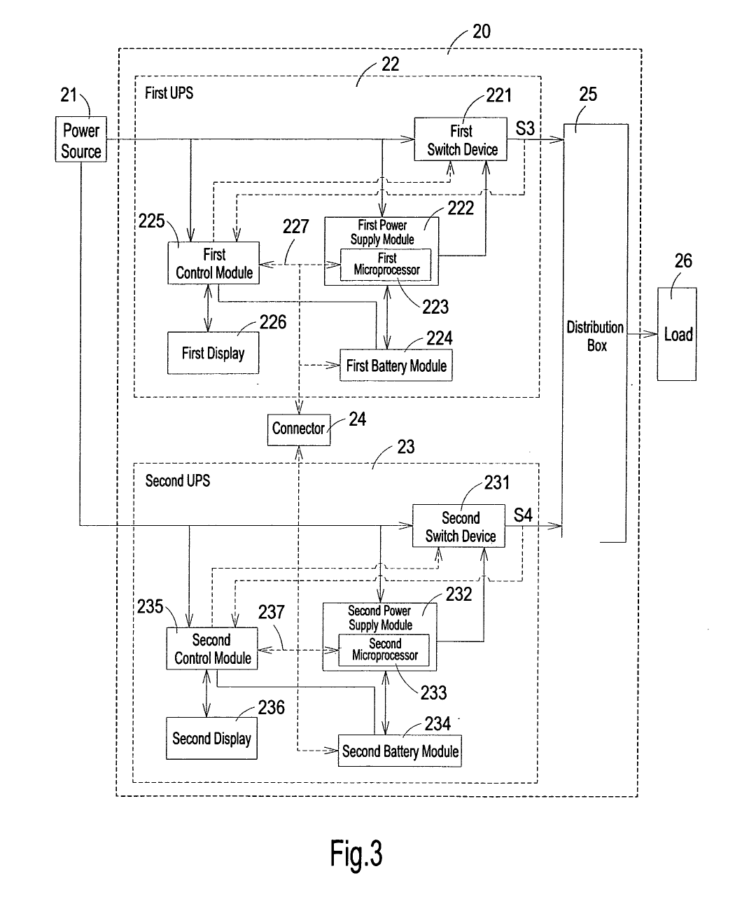

FIG. 3 illustrates a detailed circuit block diagram of a parallel UPS system according to a first preferred embodiment of the present invention. As shown in FIG. 2, a parallel uninterruptible power supply system 20 is configured to receive an input AC power from a power source 21 at one end and connect to a load 26 at the other end. The parallel UPS system 20 is made up of a first UPS 22, a second UPS 23, a connector 24, and a distribution box 25. The first UPS 22 and the second UPS 23 are configured to perform rectification, filtration and conversion to the input AC power and provide an output power respectively. The output power is distributed to the load 26 through the distribution box 25.

The first UPS 22 and the second UPS 23 are connected in parallel with each other, and both are configured to receive the input AC power from the power source 21. The first UPS 22 is made up of a first switch device 221, a first power supply module 222, a first microprocessor 223, a first battery module 224, a first control module 225, a first display 226, and a first signal transmission line 227. In a preferred aspect of the present invention, the first signal transmission line 227 is implemented with a bus device for transmitting data signal.

In the circuit block diagram of FIG. 3, the solid arrowheaded lines represent power transmission lines and the dashed arrowheaded lines represent signal transmission lines. As depicted in FIG. 3, the first switch device 221 is connected to the power source 21 and the first power supply module 222 by means of power transmission lines, and connected to the first control module 225 by means of signal transmission lines. The first switch device 221 is under the control of the first control module 225. When the first control module 225 detects that the output voltage of the first power supply module 222 is abnormal, i.e. the first power supply module 222 is malfunctioned or the AC power derived by converting the DC power received from the first battery modules 224 can not meet the requirements of the load 26, the first control module 225 issues a control signal to allow the power source 21 to provide the output voltage S3 directly by means of the first switch device 221.

The first power supply modules 222 is configured to process the AC power received from the power source 21 and supply power to the distribution box 25 through the first switch device 221, and convert the received AC power into DC power for storage in the first battery module 224. The first microprocessor 223 of the first power supply module 222 is configured to transmit the data signal associated with the system status information of the first power supply module 222 to the first control module 225. Also, the first battery module 224 is configured to transmit the data signal associated with the status information of the battery module 224 to the first control module 225.

The first control module 225 is configured to receive the data signal associated with the system status information of the first power supply module 222 and the data signal associated with the system status information of the battery module 224, and perform a corresponding control function accordingly. The first display 226 is under the control of the first control module 225 for displaying the system status information of the first UPS 22.

The first control module 225, the first microprocessor 223, and the first battery module 224 are configured to conduct data signal transmission by means of the first signal transmission line 227, so that the first control module 225, the first microprocessor 223, and the first battery module 224 can communicate with each other.

As shown in FIG. 3, the second uninterruptible power supply 23 includes a second switch device 231, a second power supply module 232, a second microprocessor 233, a second battery module 234, a second control module 235, a second display 236, and a second signal transmission line 237. In a preferred aspect of the present invention, the second signal transmission line 237 is implemented with a bus device for transmitting data signal.

It should be noted that the principle and efficacy of the second switch device 231, the second power supply module 232, the second microprocessor 233, the second battery module 234, the second control module 235, the second display 236, and the second signal transmission line 237 are similar to those of the counterpart components located within the first UPS 22, and it is not intended to give details herein.

The first signal transmission line 227 is connected to the first control module 225, the first microprocessor 223 and the first battery module 224 by means of signal transmission lines at one end, and also connected to the connector 24 by means of signal transmission lines at the other end. Likewise, the second signal transmission line 237 is connected to the second control module 235, the second microprocessor 233, and the second battery module 234 by means of signal transmission lines at one end, and also connected to the connector 24 by means of signal transmission lines at the other end. Therefore, by connecting the first signal transmission line 227 and the second signal transmission line 237 with the connector 24, the first control module 225 can receive data signal outputted from the second power supply module 232 and the second battery module 234, and the second control module 235 can receive data signal outputted from the first power supply module 222 and the first battery module 224. This would enable the first UPS 22 and the second UPS 23 to communicate directly with each other, and thereby reduce the manufacturing cost of the parallel UPS system 20. Moreover, the signal transmission rate of the data signal can be accelerated because of the direction communication between the first UPS 22 and the second UPS 23 through the first signal transmission line 227 and second signal transmission line 237, and thus the response time of the parallel UPS system 20 can be shortened.

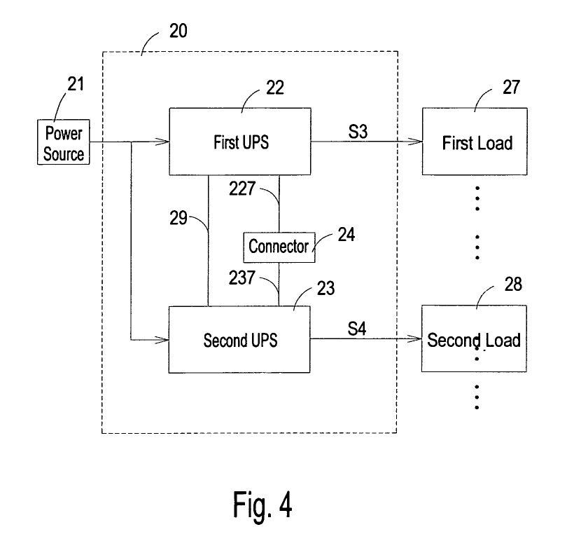

In a second preferred embodiment of the present invention, a power transmission line 29 can be connected to the first UPS 22 and the second UPS 23 to achieve a parallel redundant configuration for a single-load condition or a multi-load condition, or achieve a power distribution system with capacity upgrade mode. In such embodiment, the distribution box 25 can be eliminated so that the manufacturing cost of the parallel UPS system 20 can be further reduced. FIG. 4 is a circuit block diagram of a parallel UPS system according to a second preferred embodiment of the present invention. As depicted in FIG. 4, the parallel UPS system 20 is configured to receive an input AC power from a power source 21 at one end and connect to a first load 27 and a second load 28 at the other end for supplying an operative power for the first load 27 and the second load 28 respectively. The parallel UPS system 20 includes a first UPS 22, a second UPS 23, a first signal transmission line 227, a second signal transmission line 237, a connector 24, and a power transmission line 29.

As depicted in FIG. 4, the first UPS 22 and the second UPS 23 are connected in parallel with each other. The first UPS 22 is connected to the power source 21 and the first load 27 for receiving an input AC power from the power source 21 and outputting an operative power to the first load 27. The second UPS 23 is connected to the power source 21 and the second load 28 for receiving an input AC power from the power source 21 and outputting an operative power to the second load 28. The first UPS 22 and the second UPS 23 are configured to communicate with each other by means of the first signal transmission line 227, the second signal transmission line 237, and the connector 24. It is to be noted that the design rule of the UPS system 20 according to the present embodiment is the same as the design rule of the UPS system 20 according to the previous embodiment, and it is not intended to give details herein. Besides, the power transmission line 29 serves as a medium for first UPS 22 and the second UPS 23 to transmit and distribute the output power.

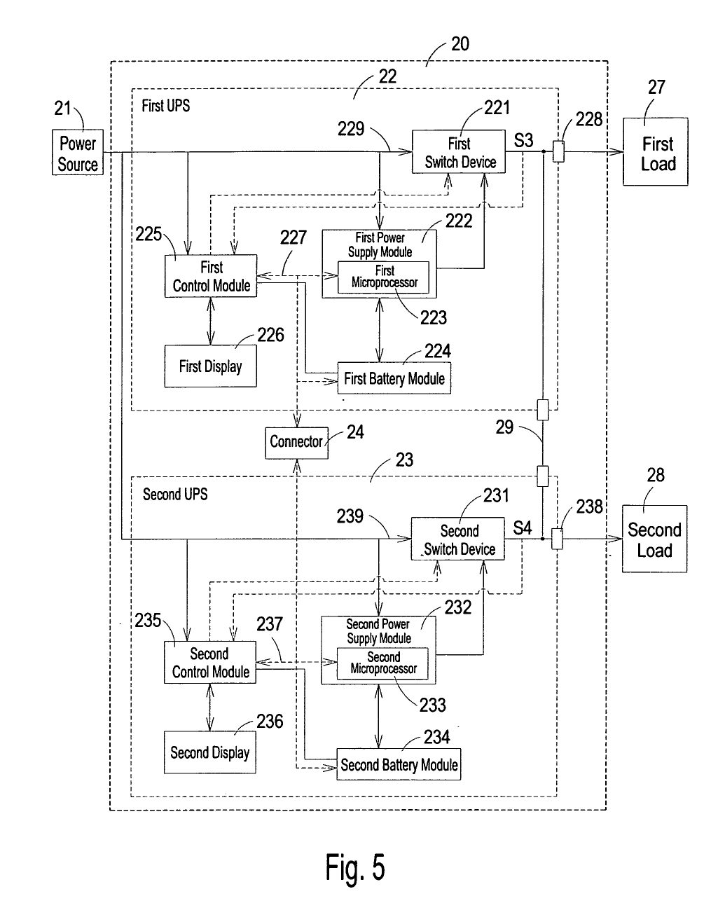

FIG. 5 is a circuit block diagram detailing the internal circuitry of the UPS system of FIG. 4. In this embodiment, the internal circuitry of the first uninterruptible power supply 22 and the internal circuitry of the second uninterruptible power supply 23 are similar to those described in the previous embodiment, and it is not intended to give details herein. One end of the power transmission line 29 is connected between a first switch device 221 and a first voltage output terminal 228, and the other end of the power transmission line 29 is connected between a second switch device 231 and a second voltage output terminal 238. In order to prolong the lifetime of the uninterruptible power supplies mounted within the parallel UPS system 20 and enhance the reliability of the output power of the uninterruptible power supply system, the communication between the first uninterruptible power supply 22 and the second uninterruptible power supply 23 is carried out by means of the first signal transmission line 227 located within the first UPS 22, the second signal transmission line 237 located within the second UPS 23, and the connector 24, so that the operative power for the first load 27 and the second load 28 can be equally shared by the first UPS 22 and the second UPS 23 to achieve balance on load sharing. After the communication between the first UPS 22 and the second UPS 23 is completed, the first uninterruptible power supply 22 or the second uninterruptible power supply 23 can supply a portion of its output power to the other uninterruptible power supply by means of the power transmission line 29 according to the result of communication, and thus the uninterruptible power supply at the power receiving end can supply the sum of its output power plus the received output power to the load connected therewith. For example, the first load 27 requires an operative power of 3 kva and the second load 28 requires an operative power of 2 kva. If the communication between the first UPS 22 and the second UPS 23 through the first signal transmission line 227, the second signal transmission line 237 and the connector 24 determines that the first UPS 22 and the second UPS 23 equally share the operative power for the first load 27 and the second load 28, each of the first UPS 22 and the second UPS 23 provides an output power of (3 kva+2 kva)/2=2.5 kva. Because the second load 28 to which the second UPS 23 is connected requires an operative power of 2 kva, 2 kva out of the output power of the second UPS 23 is provided to the second load 28 and 0.5 kva out of the output power of the second UPS 23 is delivered to the first UPS 22 through the power transmission line 29. Thus, the first UPS 22 can provide the sum of its output power plus the output power delivered from the second UPS 23 to the first load 27, that is, 2.5 kva+0.5 kva=3 kva, as the operative power for the first load 27.

In the present embodiment, the power transmission line 29 can be a hard wire for transmitting electric power or any hard wires with sufficient capacity, all of which are without departing the scope of the present invention.

Certainly, the parallel UPS system 20 according to a preferred embodiment of the present invention has a parallel redundant mode and a capacity upgrade mode, and their operating principles are described as follows:

1. Parallel Redundant Mode:

The principle of a parallel redundant mode operation is described as follows: If one of the uninterruptible power supplies 22 and 23 can not operate due to an aged battery or faulty electronic parts, the other uninterruptible power supply is required to increase its share of the operative power for the load and transmit a portion of its output power to the malfunctioned uninterruptible power supply through the power transmission line 29 to provide the operative power to the load instead of the malfunctioned uninterruptible power supply. On the other hand, the output power S3 of the first UPS 22 is limited to the rated output capacity P1 for the output end 228, like a socket element of the first UPS 22. Also, the output power S4 of the second UPS 23 is limited to the rated output capacity P2 for the output end 229, like a socket element of the second UPS 23. Therefore, in order to enable the first UPS 22 and the second UPS 23 to operate under a parallel redundant mode, the relationship between the output power S3, S4 and the sum S5 of the output power S3 and the output power S4 should satisfy the following condition:

S3≦P1, S4≦P2 and S5≦(P1+P2)/2

For example, both of the rated output capacities P1, P2 are set to 5 kva. In order to comply with the requirements for parallel redundant operation, the output power S3, S4 and the sum S5 of the output power S3 and the output power S4 must satisfy the condition of S3,S4≦5 kva and S5≦(5+5)/2 kva. As an example, the first load 27 to which the first UPS 22 is connected requires an operative power of 3 kva, and the second load 28 to which the second UPS 23 is connected requires an operative power of 2 kva. That is, the output power S3 should be 3 kva and the output power S4 should be 2 kva, and the total output power S5 should be 2 kva+3 kva=5 kva.

When the first UPS 22 and the second UPS 23 are operating under a normal condition, the first UPS 22 and the second UPS 23 communicate with each other by means of the first signal transmission line 227, the second first signal transmission line 237, and the connector 24. If the result of the communication indicate that the first UPS 22 and the second UPS 23 equally share the operative power for the first load 27 and the second load 28, i.e. each of the first UPS 22 and the second UPS 23 is required to supply an output power of (3 kva+2 kva)/2=2.5 kva. Because the second load 28 to which the second uninterruptible power supply 23 is connected requires an operative power of 2 kva only, 2 kva out of the output power of the second UPS 23 is outputted to the second load 28 and 0.5 kva out of the output power of the second UPS 23 is delivered to the first UPS 22 through the power transmission line 29 to achieve balance on load sharing. Under this condition, the sum of the output power generated by the first UPS 22 and the output power delivered from the second UPS 23, i.e. 2.5 kva+0.5 kva=3 kva, is supplied to the first load 27 as the operative power for first load 27.

If one of the first UPS 22 and the second UPS 23 is malfunctioned, the other one is obliged to increase its share of operative power for the load and replace the malfunctioned uninterruptible power supply for supplying the operative power for the load. For example, if the second UPS 23 is malfunctioned and becomes inoperable, the first UPS 22 is obliged to increase its output power from 2.5 kva to 5 kva. That is, the total operative power for the first load 27 and the second load 28 is entirely supplied from the first UPS 22, in which 3 kva out of the output power of the first UPS 22 is outputted to the first load 27 and 2 kva out of the output power of the first UPS 22 is delivered to the second UPS 23 through the power transmission line 29 for output to the second load 28, and thereby accomplish a parallel redundant operation.

2. Capacity Upgrade Mode:

Under this mode, the first UPS 22 and the second UPS 23 do not possess the parallel redundant functionality as stated above. However, the total output power of the first UPS 22 and the second UPS 23 can be maximized to the sum of the rated output capacity P1 of the first UPS 22 and the rated output capacity P2 of the second UPS 23, i.e. S5≦(P1+P2). In this manner, the output power of the parallel UPS system 20 can be upgraded significantly. Besides, the output power S3 of the first UPS 22 and the output power S4 of the second UPS 23 are respectively limited by the rated output capacity P1, P2 for the voltage output terminal 228, 238, like socket elements, and thus the output power S3 and S4 should satisfy the condition of S3≦P1, S4≦P2. For example, both of the rated output capacities P1 and P2 for the first voltage output terminal 228 and the second voltage output terminal 238 of the first UPS 22 and the second UPS 23 are 5 kva. In order to comply with the requirements for the capacity upgrade mode, the output power S3 and the output power S4 have to comply with the condition of S3, S4≦5 kva. As an example, the first load 27 to which the first UPS 22 is connected requires an operative power of 5 kva and the second load 28 to which the second UPS 23 is connected requires an operative power of 3 kva. That is, the output power S3 is 5 kva and the output power S4 is 3 kva, and the total output power S5 is 5 kva+3 kva=8 kva.

When the first UPS 22 and the second UPS 23 are operating normally, the first UPS 22 and the second UPS 23 can communicate with each other by means of the first signal transmission line 227, the second signal transmission line 237, and the connector 24. If the result of communication determines that the uninterruptible power supplies equally share the operative power for the first load 27 and the second load 28, each of the first uninterruptible power supply 22 and the second uninterruptible power supply 23 is set to provide an output power of (5 kva+3 kva)/2=4 kva. However, the second load 28 to which the second uninterruptible power supply 23 is connected requires an operative power of 3 kva only, so that 3 kva out of the output power of the second UPS 23 is outputted to the second load 28 and 1 kva out of the output power of the second UPS 23 is delivered to the first UPS 22. The first uninterruptible power supply 22 can supply a total output power of its output power plus the output powered delivered from the second UPS 23 to the first load 27 for powering the first load 27.

When one of the first UPS 22 and the second UPS 23 is malfunctioned, the first UPS 22 and the second UPS 23 do not possess the parallel redundant functionality under the capacity upgrade mode. Hence, the operative power required for powering the first load 27 is supplied from the power source 21 through a bypass route 229 located within the first UPS 22, and the operative power required for operating the second load 28 is supplied from the power source through a bypass route 239 located within the second UPS 23.

By connecting the first UPS 22 and the second UPS 23 with the power transmission line 29, the parallel UPS system 20 can provide a parallel redundant mode or capacity upgrade mode to improve the power distribution for the load. Also, the distribution box can be further removed from the parallel UPS system 20 so as to reduce the manufacturing cost of the UPS system 20 and avoid the inconvenience of assembling the distribution box.

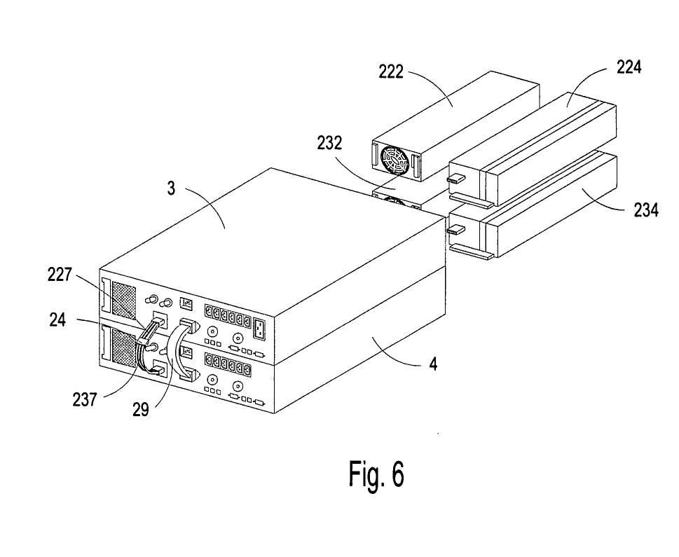

FIG. 6 is an elevation view of a parallel UPS system according to a preferred embodiment of the present invention. As shown in FIG. 6, the first UPS 22 and the second UPS 23 are placed inside a first housing 3 and a second housing 4, respectively. The first power supply module 222, the second power supply module 232, the first battery module 224, and the second battery module 234 are hot swappable modules. Therefore, the power modules and the battery modules of the uninterruptible power supplies are interchangeable and replaceable to reduce the cost of maintenance and repair.

In conclusion, the internal uninterruptible power supply of the inventive parallel uninterruptible power supply system can perform signal transmission directly by signal transmission lines, so that the control module of each uninterruptible power supply can receive data signal outputted from the power supply modules and battery modules of other uninterruptible power supplies. Therefore, the internal uninterruptible power supplies can communicate with each other without the need of an external communication port, and thus the manufacturing cost of the parallel uninterruptible power supply system can be reduced, so that the signal transmission rate of the parallel uninterruptible power supplies can be accelerated and the response time of the entire uninterruptible power supply system can be shortened.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A parallel uninterruptible power supply system comprising:
a first uninterruptible power supply, comprising:
a first control module;
a first power supply module;
a first battery module;
a first signal transmission line connected to the first control module, the first power supply module, and the first battery module for transmitting a data signal outputted from the first power supply module and the first battery module to the first control module;
a second uninterruptible power supply, comprising:
a second control module;
a second power supply module;
a second battery module;
a second signal transmission line connected to the second control module, the second power supply module and the second battery module for transmitting a data signal outputted from the second power supply module and the second battery module to the second control module; and
a connector connected with the first signal transmission line and the second signal transmission line for allowing the first control module to receive a data signal outputted from the second power supply module and the second battery module, and allowing the second control module to receive a data signal outputted from the first power supply module and the first battery module, so as to allow the first uninterruptible power supply and the second uninterruptible power to communicate with each other.

2. The parallel uninterruptible power supply system according to claim 1 wherein both of the first signal transmission line and the second signal transmission are a bus device for transmitting a data signal.

3. The parallel uninterruptible power supply system according to claim 1 wherein both of the first uninterruptible power supply and the second uninterruptible power are configured to receive an input power from a power source.

4. The parallel uninterruptible power supply system according to claim 3 wherein the power source is a commercial power source.

5. The parallel uninterruptible power supply system according to claim 3 wherein the first uninterruptible power supply further comprises:
a first switch device connected to the power source, the first power supply module and the first control module and controlled by the first control module;
a first microprocessor for outputting and transmitting a data signal to the first control module; and
a first display connected to the first control module for displaying a system status information of the first uninterruptible power supply.

6. The parallel uninterruptible power supply system according to claim 5 wherein the second uninterruptible power supply comprises:
a second switch device connected to the power source, the second power supply module and the second control module and controlled by the second control module;
a second microprocessor for outputting and transmitting a data signal to the second control module; and
a second display connected to the second control module for displaying a system status information of the second uninterruptible power supply.

7. The parallel uninterruptible power supply system according to claim 6 further comprising a distribution box connected to the first uninterruptible power supply, the second uninterruptible power supply and the load for distributing an output power of the first uninterruptible power supply and an output power of the second uninterruptible power supply to the load.

8. The parallel uninterruptible power supply system according to claim 6 further comprising a power transmission line connected to the first switch device and a first voltage output terminal at one end and connected to the second switch device and a second voltage output terminal at the other end for enabling the first uninterruptible power supply and the second uninterruptible power supply to transmit and distribute an output power.

9. The parallel uninterruptible power supply system according to claim 8 wherein the first uninterruptible power supply is configured to receive an input power from the power source and connected to a first load for outputting an output power to the first load.

10. The parallel uninterruptible power supply system according to claim 9 wherein the second uninterruptible power supply is configured to receive the input power from the power source and connected to a second load for outputting an output power to the second load.

11. The parallel uninterruptible power supply system according to claim 10 wherein the output power of the first uninterruptible power supply is smaller than a rated output capacity of the first uninterruptible power supply.

12. The parallel uninterruptible power supply system according to claim 11 wherein the output power of the second uninterruptible power supply is smaller than a rated output capacity of the second uninterruptible power supply.

13. The parallel uninterruptible power supply system according to claim 12 wherein the first uninterruptible power supply and the second uninterruptible power supply are operating under one of a parallel redundant mode and a capacity upgrade mode.

14. The parallel uninterruptible power supply system according to claim 13 wherein both of the first voltage output terminal and the second voltage output terminal are a socket element.

15. The parallel uninterruptible power supply system according to claim 1 further comprising:
a first housing configured to receive the first uninterruptible power supply; and
a second housing configured to receive the second uninterruptible power supply.

16. The parallel uninterruptible power supply system according to claim 15 wherein the first power supply module and the first battery module are hot swappable within the first housing, and the second power supply module and the second battery module are hot swappable within the second housing.
